(19) United States
(12) Patent Application Publication
(10) Pub. No.: US 2025/0047483 A1
(43) Pub. Date: Feb. 6, 2025

(54) ELECTRONIC DEVICE AND INFORMATION PROCESSING METHOD

(71) Applicant: Sony Semiconductor Solutions Corporation, Kanagawa (JP)

(72) Inventor: Shingo Miyajima, Kanagawa (JP)

(21) Appl. No.: 18/714,744

(22) PCT Filed: Dec. 6, 2022
(86) PCT No.: PCT/JP2022/044948

§ 371 Date: May 30, 2024

(30) Foreign Application Priority Data
Dec. 27, 2021 (JP) 2021-212201

(51) Int. Cl. H04L 9/30; H04L 9/08

(52) U.S. Cl. CPC H04L 9/30; H04L 9/0861

(57) ABSTRACT

An electronic device includes a first authenticity determination processing unit that performs, on target data, first authenticity determination with a public key cryptosystem, a code data generation unit that generates, from the target data determined to be true in the first authenticity determination, code data with a common key cryptosystem, and a second authenticity determination processing unit that performs second authenticity determination on the target data by using the code data.

### TECHNICAL FIELD

The present technology relates to an electronic device and an information processing method, and particularly relates to technology of an electronic device and an information processing method that perform processing indicating that data is unaltered.

### BACKGROUND ART

There are several methods for verifying that information handled by an electronic device is unaltered.

For example, there are known a “public key cryptosystem” for verifying by using a private key and a public key that target data is unaltered (refer to Non-Patent Documents 1 and 2 below), a “common key cryptosystem” for verifying by using a common key that target data is unaltered (refer to Non-Patent Document 3 below), and the like are known.

### CITATION LIST

### Non-Patent Document

Non-Patent Document 1: L. Chen, D. Moody, A. Regenscheid, K. Randall, Recommendations for Discrete Logarithm-Based Cryptography: Elliptic Curve Domain Parameters, Draft NIST Special Publication 800-186, October 2019. Website <URL:https://csrc.nist.gov/publications/detail/sp/800-186/draft>
Non-Patent Document 2: RSA Cryptography Specifications Version 2.2 Website <URL:https://datatracker.ietf.org/doc/html/rfc8017>
Non-Patent Document 3: Recommendation for Block Cipher Modes of Operation Website <URL:https://nvlpubs.nist.gov/nistpubs/Legacy/SP/nistspec ialpublication800-38a.pdf>

### SUMMARY OF THE INVENTION

### Problems to be Solved by the Invention

The public key cryptosystem has a problem that a computational amount is large and processing time is long as compared with the common key cryptosystem.

Furthermore, the common key cryptosystem has a problem that risk costs are high as compared with the public key cryptosystem.

The present technology is intended to solve the problems described above, and an object thereof is to reduce risk costs while reducing an amount of computation for processing of determining whether or not an alteration has been made.

### Solutions to Problems

An electronic device according to the present technology includes a first authenticity determination processing unit that performs, on target data, first authenticity determination with a public key cryptosystem, a code data generation unit that generates, from the target data determined to be true in the first authenticity determination, code data with a common key cryptosystem, and a second authenticity determination processing unit that performs second authenticity determination on the target data by using the code data.

By generating the code data (message authentication code: MAC) with the common key cryptosystem by using the target data determined to be “true” by the first authenticity determination processing, the code data can be used for the second authenticity determination processing for determining authenticity of the target data. Because the second authenticity determination processing is processing with the common key cryptosystem, the second authenticity determination processing has processing time shorter than the first authenticity determination processing with the public key cryptosystem does.

In information processing method according to the present technology, a computer apparatus executes first authenticity determination processing on target data with a public key cryptosystem, code data generation processing of generating, from the target data determined to be true in the first authenticity determination processing, code data with a common key cryptosystem, and second authenticity determination processing of performing second authenticity determination on the target data by using the code data.

The electronic device described above can be implemented by such an information processing method.

### BRIEF DESCRIPTION OF DRAWINGS

FIG. 1 is a block diagram for describing a configuration of an information processing system.

FIG. 2 is a diagram for describing an overview of a procedure executed by each device.

FIG. 3 is a flowchart illustrating an example of a flow of processing for an electronic device to perform authenticity determination.

FIG. 4 is a flowchart illustrating an example of a flow of processing executed by the electronic device in a case where a public key and a common key are stored in the electronic device.

FIG. 5 is a flowchart illustrating an example of a flow of processing executed by the electronic device according to a first modification.

FIG. 6 is a flowchart illustrating an example of a flow of processing executed by the electronic device according to a second modification.

FIG. 7 is a flowchart illustrating an example of a flow of processing executed by the electronic device according to a third modification.

FIG. 8 is a flowchart illustrating an example of a flow of processing executed by the electronic device according to a fourth modification.

FIG. 9 is a diagram for describing an overview of a procedure executed by each device according to a fifth modification.

### MODE FOR CARRYING OUT THE INVENTION

Hereinafter, an embodiment will be described in the following order.

<1. System configuration>
<2. Processing procedure in each apparatus>

### <3. Modifications>

<3-1. First modification>
<3-2. Second modification>
<3-3. Third modification>
<3-4. Fourth modification>
<3-5. Fifth modification>
<3-6. Other modifications>

### <4. Conclusion>

<5. Present technology>

### 1. SYSTEM CONFIGURATION

Authenticity determination of target data requires processing of generating various keys, digital signatures, and the like, processing of storing data thereof, and the like. Then, there are various possible aspects of configuration for performing the authenticity determination.

Here, first, one embodiment of an information processing system S will be described.

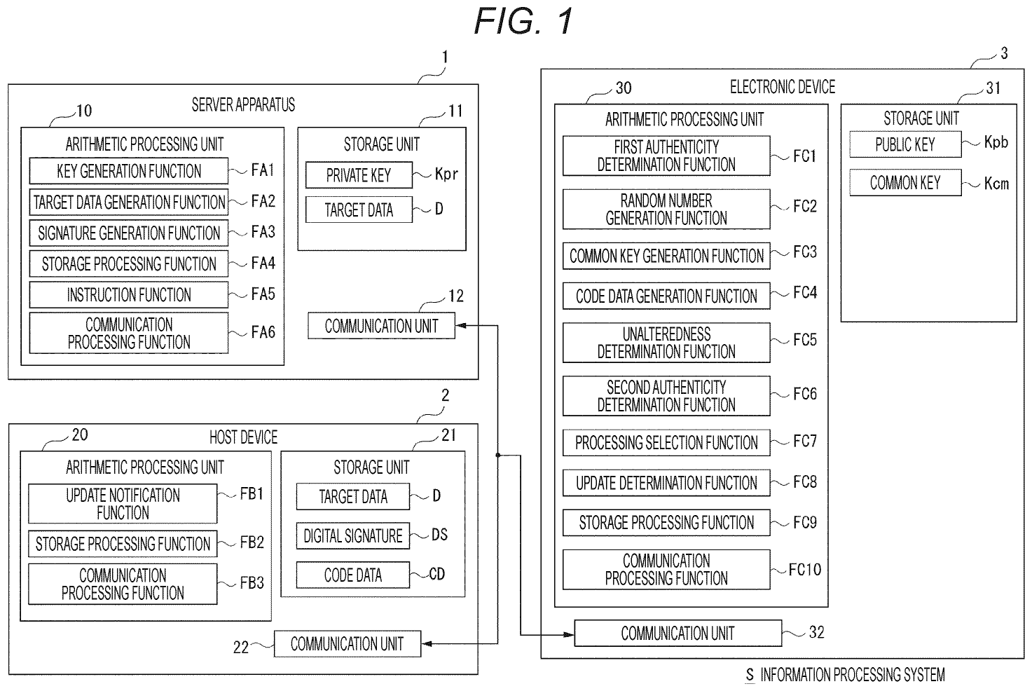

As illustrated in FIG. 1, the information processing system S includes a server apparatus 1, a host device 2, and an electronic device 3.

In the following example, the server apparatus 1 is, for example, an apparatus for manufacturing an image sensor. Furthermore, the host device 2 is, for example, a camera device on which the image sensor is mounted. Moreover, the electronic device 3 is the image sensor manufactured by the server apparatus 1.

The server apparatus 1 is an apparatus that performs processing of generating various keys and data to be subjected to authenticity determination (hereinafter referred to as “target data D”), and of transmitting necessary data to another device.

The server apparatus 1 includes an arithmetic processing unit 10, a storage unit 11, and a communication unit 12.

The arithmetic processing unit 10 has a key generation function FA1, a target data generation function FA2, a signature generation function FA3, a storage processing function FA4, an instruction function FA5, and a communication processing function FA6.

The key generation function FA1 generates a private key Kpr utilized in the public key cryptosystem and a public key Kpb paired with the private key Kpr. The generated private key Kpr is stored in the storage unit 11. Furthermore, the generated public key Kpb is transmitted to the electronic device 3.

The target data generation function FA2 generates the target data D, which is data to be proved as being unaltered, that is, data to be subjected to authenticity determination processing. The generated target data D is first transmitted to the host device 2.

There are various types of possible target data D. For example, the target data D may be data including at least a part of a program operating in the electronic device 3 as an image sensor, may be data such as a variable utilized in the program, or may be a patch file for updating the program. Furthermore, the target data D may be data such as a program utilizing artificial intelligence (AI), an AI model utilized by the program, or the like.

The signature generation function FA3 generates digital signature DS in the public key cryptosystem by using the target data D and the private key Kpr. The generated digital signature DS is transmitted to the host device 2.

For example, in a case of the Rivest-Shamir-Adleman Cryptosystem (RSA) method, the digital signature DS is generated by encrypting hash data obtained by hashing the target data D by using the private key Kpr.

The storage processing function FA4 executes processing of storing in the storage unit 11 the private key Kpr generated by the key generation function FA1, processing of storing in the storage unit 11 the target data D to be sent to the host device 2 or the like, and processing of storing in the storage unit 11 temporary data in each piece of processing and of reading the temporary data.

The instruction function FA5 transmits, to the electronic device 3, an instruction to generate a common key Kcm utilized in a common key cryptosystem. In response to this, the electronic device 3 generates the common key Kcm. Note that, after the electronic device 3 is mounted on the host device 2, the instruction may be transmitted to the host device 2.

Furthermore, the instruction function FA5 instructs the host device 2 to update various pieces of software or the like used in the electronic device 3.

The communication processing function FA6 performs processing of transmitting to the electronic device 3 the public key Kpb generated by the key generation function FA1, processing of transmitting to the host device 2 the target data D generated by the target data generation function FA2, processing of transmitting to the host device 2 the digital signature DS generated by the signature generation function FA3, processing of transmitting, to the host device 2 or the electronic device 3, the instruction by the instruction function FA5, and the like.

The storage unit 11 includes a read only memory (ROM), a random access memory (RAM), and the like, and stores and reads various data in response to an instruction from the storage processing function FA4.

The communication unit 12 performs various types of communication between the server apparatus 1 and the host device 2, or between the server apparatus 1 and the electronic device 3, in response to an instruction from the communication processing function FA6.

The host device 2 includes an arithmetic processing unit 20, a storage unit 21, and a communication unit 22.

The arithmetic processing unit 20 has an update notification function FB1, a storage processing function FB2, and a communication processing function FB3.

In response to an update instruction received from the server apparatus 1, the update notification function FB1 performs processing of notifying the electronic device 3 that there is an update.

The storage processing function FB2 performs processing of storing, in the storage unit 21, the target data D and digital signature DS received from the server apparatus 1.

The communication processing function FB3 performs processing of receiving the target data D and digital signature DS from the server apparatus 1, processing of receiving the update instruction from the server apparatus 1, processing of transmitting the target data D and digital signature DS to the electronic device 3, and processing of transmitting, to the electronic device 3, code data CD to be described later.

The storage unit 21 includes the ROM, the RAM, and the like, and stores and reads various data in response to an instruction from the storage processing function FB2.

The communication unit 22 performs various types of communication between the host device 2 and the server apparatus 1, or between the host device 2 and the electronic device 3, in response to an instruction from the communication processing function FB3. Communication with the server apparatus 1 is performed via various communication networks, such as the Internet for example. Furthermore, communication with the electronic device 3 is performed with a communication system such as an inter-integrated circuit (I2C), for example.

As described above, for example, the electronic device 3 is an image sensor or the like mounted on a camera apparatus serving as the host device 2, and is a device that performs processing by actually using target data D unaltered.

The electronic device 3 includes an arithmetic processing unit 30, a storage unit 31, and a communication unit 32.

The arithmetic processing unit 30 has a first authenticity determination function FC1, a random number generation function FC2, a common key generation function FC3, a code data generation function FC4, an unalteredness determination function FC5, a second authenticity determination function FC6, a processing selection function FC7, an update determination function FC8, a storage processing function FC9, and a communication processing function FC10.

By using the target data D, the public key Kpb, and the digital signature DS, the first authenticity determination function FC1 performs first authenticity determination for proving that the target data D is unaltered. For example, in a case of the RSA method, in the first authenticity determination, hash data obtained from the digital signature DS with the decryption processing using the public key Kpb is compared with hash data obtained by hashing the target data D.

In a case where the two pieces of hash data match, the target data D is determined to be “true”, and the target data D is determined to be unaltered.

Meanwhile, in a case where the two pieces of hash data do not match, the target data D is determined to be “not true”, and the target data D is determined to be altered.

Note that there are various types of possible encryption techniques such as elliptic curve cryptography (ECC) and RSA for example, as an encryption technique used for the first authenticity determination function FC1.

Note that the target data D used in the first authenticity determination is acquired from another apparatus (the server apparatus 1 or the host device 2, for example) every time the electronic device 3 is activated. With this arrangement, the electronic device 3 may not include a storage unit for storing the target data D. Furthermore, even if the electronic device 3 is hacked, the electronic device 3 can be operated by using the target data D newly acquired each time.

The random number generation function FC2 generates a random number for generating the common key Kcm with the common key cryptosystem. The random number generated by the random number generation function FC2 is preferably a true random number.

Note that a numerical value other than the true random number may be generated by a method that cannot be estimated from outside of the electronic device 3, and the numerical value may be used to generate the common key Kcm. Examples of such a method include a physically unclonable function (PUF).

The common key generation function FC3 generates the common key Kcm by using the random number generated by the random number generation function FC2. The generated common key Kcm is stored in the storage unit 31.

Note that the common key Kcm generated by the common key generation function FC3 may be unique to the electronic device 3. When the common key Kcm is unique to the electronic device 3, it is possible to minimize an extent of impact in a case where the common key Kcm is leaked.

The code data generation function FC4 generates the code data CD by using the target data D determined to be “true” by the first authenticity determination function FC1, and by using the common key Kcm generated by the common key generation function FC3. The generated code data CD is transmitted to the host device 2. Note that the code data CD is not stored in the storage unit 31 of the electronic device 3.

The code data CD is, for example, a message authentication code (MAC).

Here, processing of generating the code data CD is preferably executed inseparably from first authenticity determination processing by the first authenticity determination function FC1.

For example, if a program is altered so that a program other than a program for code data generation processing can be executed after the first authenticity determination processing, there is no point in executing the first authenticity determination by the first authenticity determination function FC1.

As an example of a configuration for inseparably executing the first authenticity determination processing and the processing of generating the code data CD, the arithmetic processing unit 30 has the unalteredness determination function FC5.

The unalteredness determination function FC5 performs processing for determining that a program related to the first authenticity determination processing and a program related to processing of generating the code data CD are unaltered. For example, by utilizing a secure boot function or the like, it is possible to verify that the program is unaltered.

Note that, even if the arithmetic processing unit 30 of the electronic device 3 does not have the unalteredness determination function FC5, it is possible to ensure unalteredness of the program with a storage aspect in which the program is stored in the storage unit 31.

For example, a program for executing the first authenticity determination processing and a program for executing processing of generating the common key Kcm may be stored in the storage unit 31 generally referred to as a mask ROM.

By these methods, the first authenticity determination processing and the processing of generating the code data CD can be inseparably executed.

The second authenticity determination function FC6 is, for example, a function that may be utilized in a second or subsequent activation of the electronic device 3.

For example, the second authenticity determination function FC6 is utilized in a case where the code data CD for the target data D is generated in a first activation of the electronic device 3, and the target data D is utilized also in a second activation of the electronic device 3.

In the second activation of the electronic device 3, second authenticity determination having a shorter processing time than the first authenticity determination does is executed.

Specifically, the second authenticity determination function FC6 acquires the target data D and code data CD from the host device 2, and compares code data CD generated again from the target data D by using the common key Kcm, with the code data CD acquired from the host device 2.

In a case where the two pieces of code data CD match, the target data D is determined to be “true”, and the target data D is determined to be unaltered.

Meanwhile, in a case where the two pieces of code data CD do not match, the target data D is determined to be “not true”, and the target data D is determined to be altered.

Note that there are various types of possible encryption techniques such as a cipher-based message authentication code (CMAC), as the encryption technique used by the second authenticity determination function FC6.

Note that the target data D used in the second authenticity determination is acquired from another apparatus (the server apparatus 1 or the host device 2, for example) every time the electronic device 3 is activated.

The processing selection function FC7 performs processing of selecting which processing, the first authenticity determination or the second authenticity determination, is performed in order to determine that the target data D is unaltered.

For example, in a case where a current activation of the electronic device 3 is the first activation utilizing the target data D, the first authenticity determination processing is selected. Meanwhile, in a case where a current activation of the electronic device 3 is the second or subsequent activation utilizing the target data D, the second authenticity determination processing is selected.

In other words, the first authenticity determination processing is selected in a case where the code data CD for the target data D has not been generated, and the second authenticity determination processing is selected when the code data CD for the target data D has been generated.

Note that, in a case where there is the patch file for updating the target data D, it is the first time that the target data D to which the patch file is applied is utilized, even if the current activation of the electronic device 3 is the second or subsequent activation utilizing the target data D. Therefore, the processing selection function FC7 determines that the current activation is the first activation and selects the first authenticity determination processing.

In the following description, the first activation utilizing the target data D will be described as an “initial activation”, and the second activation utilizing the target data D will be described as a “non-initial activation”. Then, activation in a case where the patch file for update can be utilized will be described as an “initial activation”.

The update determination function FC8 determines whether or not the target data D is to be updated, that is, whether or not there is a patch file to be applied to the target data D. The determination is made on the basis of whether or not there is notification from the update notification function FB1 of the host device 2. Furthermore, a determination result from update determination processing is utilized by the processing selection function FC7.

The storage processing function FC9 performs processing of storing in the storage unit 31 the public key Kpb received from the server apparatus 1, processing of storing in the storage unit 31 the common key Kcm generated by the common key generation function FC3, processing of temporarily storing in the storage unit 31 the target data D and code data CD received from the host device 2, and the like.

The communication processing function FC10 performs processing of receiving the public key Kpb from the server apparatus 1, processing of transmitting the code data CD to the host device 2, processing of receiving the target data D and code data CD from the host device 2, and the like. Note that, in the present embodiment, the communication processing function FC10 receives the target data D from another device every time the electronic device 3 is activated.

The arithmetic processing unit 30 performs various types of processing other than the processing described above. Examples of the processing include, in a case where there is the patch file to be applied to the target data D, processing of applying the patch file to the target data D to generate new target data D. Note that the processing of applying the patch file to the target data D may be executed in the server apparatus 1 or in the host device 2.

The storage unit 31 includes the ROM, the RAM, and the like, and stores and reads various data in response to an instruction from the storage processing function FC9.

The communication unit 32 performs communication between the electronic device 3 and the host device 2 in response to an instruction from the communication processing function FC10.

### 2. PROCESSING PROCEDURE IN EACH APPARATUS

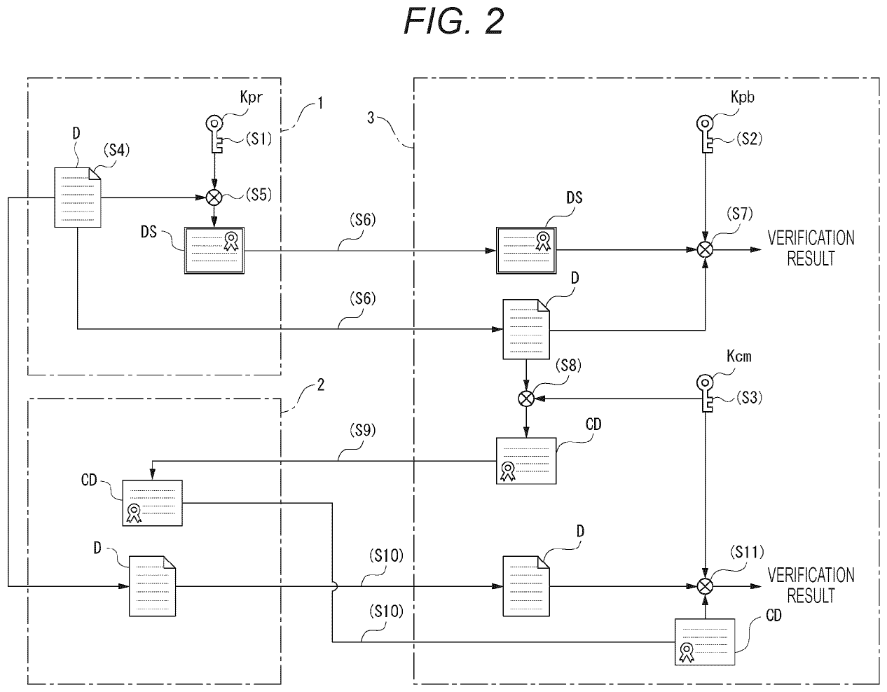

A procedure for each piece of processing of the above-described processing executed by the server apparatus 1, the host device 2, and the electronic device 3 will be described with reference to FIG. 2.

First, in Step S1, the private key Kpr and public key Kpb in the public key cryptosystem are generated in the server apparatus 1, and the private key Kpr is stored in the storage unit 11 of the server apparatus 1.

Furthermore, in Step S2, the server apparatus 1 transmits the public key Kpb to the electronic device 3 and causes the storage unit 31 of the electronic device 3 to store the public key Kpb.

In Step S3, the electronic device 3 generates the common key Kcm in the common key cryptosystem and stores the common key Kcm in the storage unit 31.

Note that each piece of processing in Steps S1 to S3 is performed, for example, in a process of manufacturing an image sensor as the electronic device 3.

Note that, as described above, the first authenticity determination may be performed by transmitting the target data D and the digital signature DS from the server apparatus 1 to the host device 2, and transmitting the target data and the digital signature DS from the host device 2 to the electronic device 3 at a time of an initial activation of the electronic device 3 for the target data D. In this case, as illustrated in FIG. 1, the digital signature DS is stored in the storage unit 21 of the host device 2.

As another method, it is conceivable that the initial activation is completed in the process of manufacturing the electronic device 3 as the image sensor. In this case, it is not necessary to cause the storage unit 21 of the host device 2 to store the digital signature DS. The example illustrated in FIG. 2 illustrates an example in which the initial activation is completed in the manufacturing process.

Specifically, in Step S4, the server apparatus 1 generates the target data D, such as program data, that is to operate in the electronic device 3. The generated target data D is transmitted to the host device 2, but a timing of the transmission may not be a timing of executing Step S4.

In Step S5, the server apparatus 1 generates the digital signature DS by using the target data D and the private key Kpr.

In Step S6, the server apparatus 1 transmits the target data D and the digital signature DS to the electronic device 3.

In Step S7, the electronic device 3 performs the first authenticity determination processing (signature verification processing) using the target data D, the digital signature DS, and the public key Kpb. As a result, the electronic device 3 can obtain whether or not the target data D has been altered, that is, can obtain information about a result of the first authenticity determination.

In Step S8, the electronic device 3 generates the code data CD such as the MAC, by using the target data D determined to be “true” by the first authenticity determination, and by using the common key Kcm.

Note that, as described above, the example illustrated in FIG. 2 is an example in which at least the processing up to Step S8 is completed in the process of manufacturing the electronic device 3 as the image sensor.

In Step S9, the generated code data CD is transmitted to the host device 2. The processing in and after Step S9 may be executed after the electronic device 3 as the image sensor is mounted on the host device 2 as the camera apparatus.

The initial activation of the electronic device 3 is completed by each piece of processing from Step S4 to Step S9, and the electronic device 3 can utilize the target data D.

Each piece of processing in and after Step S10 is processing related to the non-initial activation.

In Step S10, the host device 2 transmits the target data D and the code data CD to the electronic device 3.

In Step S11, the electronic device 3 performs the second authenticity determination processing (message authentication) using the target data D, the code data CD, and the common key Kcm. As a result, the electronic device 3 can obtain whether or not the target data D has been altered, that is, can obtain information about a result of the second authenticity determination.

The non-initial activation of the electronic device 3 is completed by each piece of processing from Step S10 to Step S11, and the electronic device 3 can utilize the target data D.

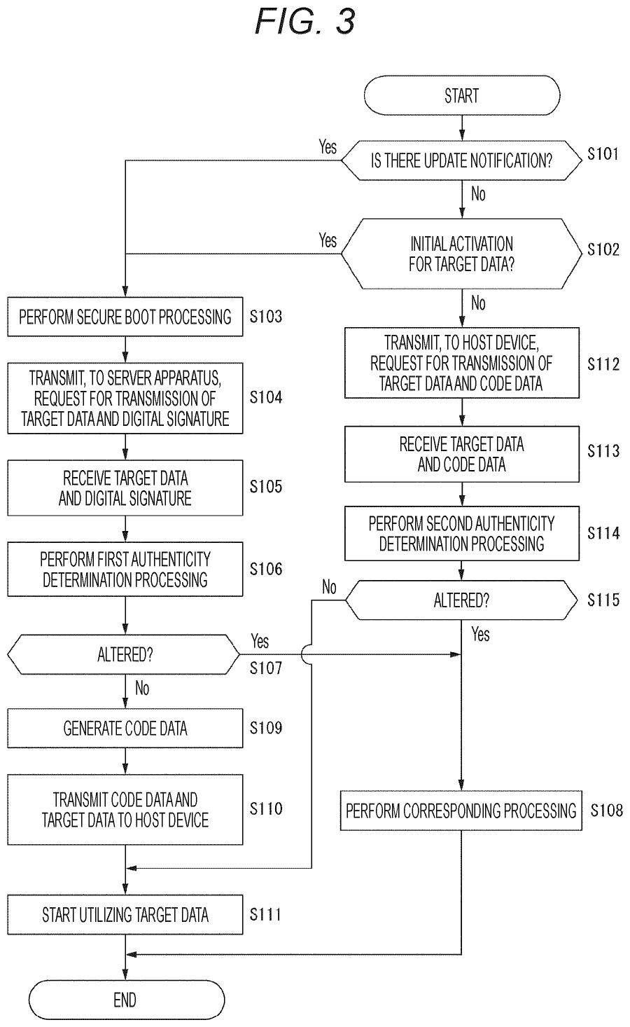

FIG. 3 is a flowchart illustrating a flow of processing executed by the electronic device 3 at a time of activation, for achieving the flow of processing described above. Note that, at a time of executing the processing illustrated in FIG. 3, the public key Kpb and the common key Kcm are stored in the storage unit 31 of the electronic device 3.

In Step S101, the arithmetic processing unit 30 of the electronic device 3 checks whether or not there is an update notification. In a case where there is no update notification, the arithmetic processing unit 30 determines in Step S102 whether or not the activation is the initial activation for the target data D.

In a case where the arithmetic processing unit 30 determines in Step S101 that there is the update notification, or determines in Step S102 that the activation is the initial activation for the target data D, the arithmetic processing unit 30 executes each piece of processing for the initial activation.

Specifically, the arithmetic processing unit 30 performs secure boot processing in Step S103. With this arrangement, it is possible to execute unalteredness determination processing for ensuring that the program related to the first authenticity determination processing and the program related to processing of generating the code data CD are not altered.

In Step S104, the arithmetic processing unit 30 transmits, to the server apparatus 1 or the host device 2, a request for transmission of the target data D and the digital signature DS.

In Step S105, the arithmetic processing unit 30 receives the target data D and the digital signature DS.

In Step S106, the arithmetic processing unit 30 performs the first authenticity determination processing.

In Step S107, the arithmetic processing unit 30 performs branching processing corresponding to a processing result of the first authenticity determination processing. Specifically, the arithmetic processing unit 30 determines whether or not the target data D has been altered, and in a case where it is determined that the target data D has been altered, the arithmetic processing unit 30 performs corresponding processing in Step S108.

There are examples of various types of possible corresponding processing. For example, a user is notified of the alteration (error notification is performed), and activation of the electronic device 3 or activation of the host device 2 on which the electronic device 3 is mounted is interrupted.

Alternatively, the user may be caused to select whether or not to continue the activation while knowing that the target data D has been altered, or the activation may be continued while presenting to the user operation for interrupting the activation.

Meanwhile, in a case where it is determined that the target data D is unaltered, the arithmetic processing unit 30 prepares for the non-initial activation.

That is, in Step S109, the arithmetic processing unit 30 generates the code data CD by using the common key Kcm and the target data D.

In Step S110, the arithmetic processing unit 30 transmits the generated code data CD to the host device 2.

In Step S111, the arithmetic processing unit 30 starts utilizing the target data D. With this arrangement, the arithmetic processing unit 30 can execute, for example, a program as the target data D.

In a case where it is determined in Step S102 that the activation is not the initial activation for the target data D, the arithmetic processing unit 30 executes each piece of processing for the non-initial activation.

Specifically, in Step S112, the arithmetic processing unit 30 transmits, to the host device 2, a request for transmission of the target data D and the code data CD.

In Step S113, the arithmetic processing unit 30 receives the target data D and the code data CD from the host device 2.

In Step S114, the arithmetic processing unit 30 performs the second authenticity determination processing.

In Step S115, the arithmetic processing unit 30 performs branching processing corresponding to a result of the second authenticity determination processing. Specifically, the arithmetic processing unit 30 determines whether or not the target data D has been altered, and in a case where it is determined that the target data D has been altered, the arithmetic processing unit 30 performs the corresponding processing in Step S108, and in a case where it is determined that the target data D is unaltered, the arithmetic processing unit 30 proceeds to processing in Step S111.

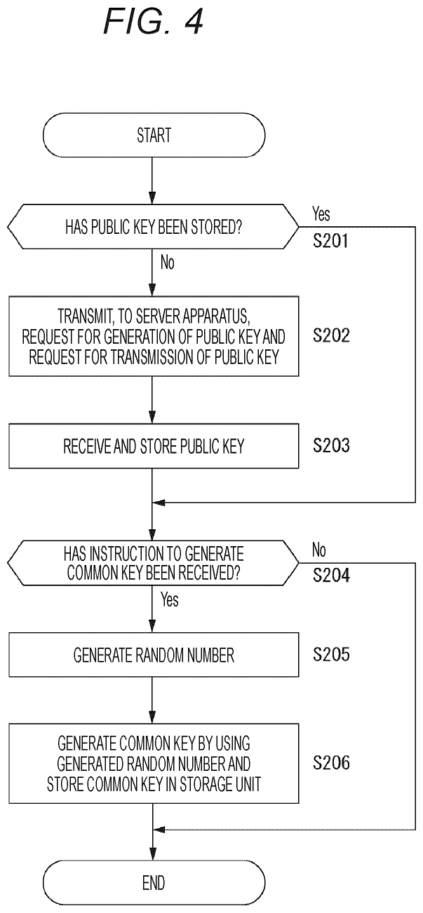

Note that the above-described processing may be achieved by a processing procedure illustrated in FIG. 4 in a case where the arithmetic processing unit 30 included in the electronic device 3 executes the program to cause the storage unit 31 of the electronic device 3 to store the public key Kpb and the common key Kcm, instead of causing the storage unit 31 to store the public key Kpb and the common key Kcm when the electronic device 3 is manufactured, without causing the arithmetic processing unit 30 included in the electronic device 3 to execute the program.

In Step S201, the arithmetic processing unit 30 determines whether or not the public key Kpb has been stored in the storage unit 31.

In a case where it is determined that the public key Kpb has been stored, the arithmetic processing unit 30 does not execute processing in Step S202 and Step S203.

Meanwhile, in a case where it is determined that the public key Kpb is not stored, in Step S202, the arithmetic processing unit 30 transmits, to the server apparatus 1, a request for generation of the public key Kpb and a request for transmission of the public key Kpb. The request may be transmitted to the server apparatus 1 via the host device 2.

In Step S203, the arithmetic processing unit 30 receives the public key Kpb from the server apparatus 1 and stores the received public key Kpb in the storage unit 31. The reception may be performed via the host device 2. The reception of the public key Kpb in the electronic device 3 is preferably performed in a state where secure communication with the server apparatus 1 or the host device 2 is established. That is, transmission and reception of the public key Kpb are preferably performed in an environment in which transmitted/received data cannot be altered or in an environment in which it is difficult to alter the transmitted/received data.

In Step S204, the arithmetic processing unit 30 determines whether or not an instruction to generate the common key Kcm has been received. The generation instruction may be issued from the server apparatus 1 as described above, or may be issued from the host device 2.

In a case where the arithmetic processing unit 30 determines that the generation instruction has been received, the arithmetic processing unit 30 generates a random number in Step S205, and generates the common key Kcm by using the generated random number and stores the common key Kcm in the storage unit 31 in Step S206.

Meanwhile, in a case where the arithmetic processing unit 30 determines that the instruction to generate the common key Kcm has not been received, the arithmetic processing unit 30 ends a series of processing illustrated in FIG. 4.

### 3. MODIFICATIONS

### 3-1. First Modification

A first modification relates to a timing of generating the common key Kcm.

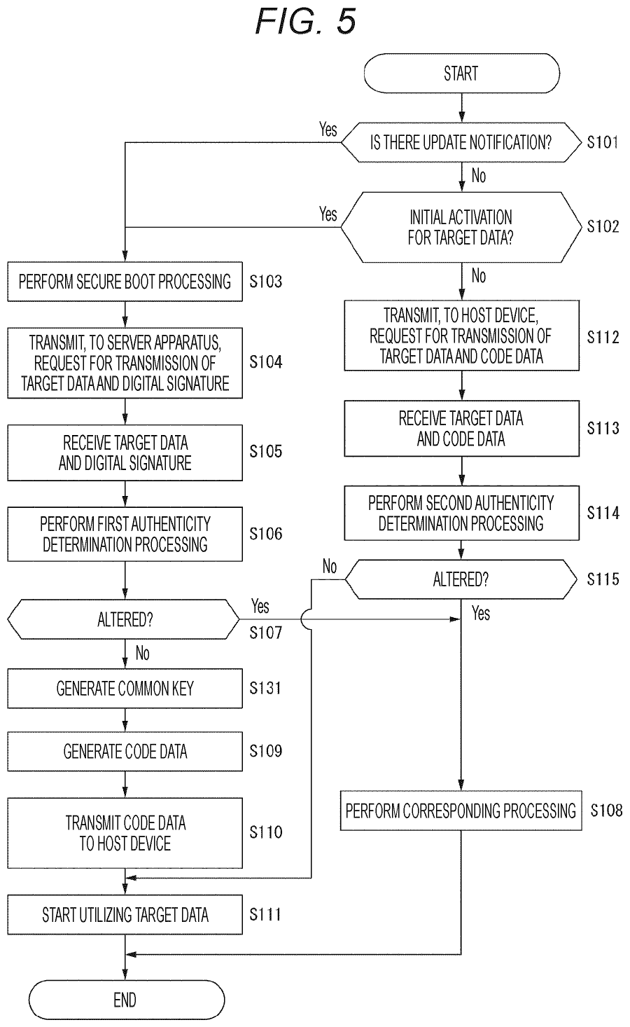

A specific processing procedure will be described with reference to FIG. 5.

Note that processing similar to each piece of processing illustrated in FIG. 3 is denoted by the same step numbers, and description thereof will be omitted as appropriate.

In a case where the arithmetic processing unit 30 of the electronic device 3 determines in Step S101 that there is the update notification, or determines in Step S102 that the activation is the initial activation for the target data D, the arithmetic processing unit 30 executes each piece of processing for the initial activation.

In each piece of processing for the initial activation, the arithmetic processing unit 30 prepares the target data D and the digital signature DS by executing Steps S103 to S106.

Subsequently, in Step S107, the arithmetic processing unit 30 performs branching processing corresponding to the processing result of the first authenticity determination processing.

In a case where the arithmetic processing unit 30 determines that the target data D is unaltered, the arithmetic processing unit 30 generates the common key Kcm in Step S131 before executing the processing in Step S109.

With this arrangement, the common key Kcm is not generated until immediately before the generation of the code data CD requiring the common key Kcm, and thus a risk of leakage of the common key Kcm can be further reduced.

### 3-2. Second Modification

A second modification is an example in which the code data CD is stored in the storage unit 31 of the electronic device 3.

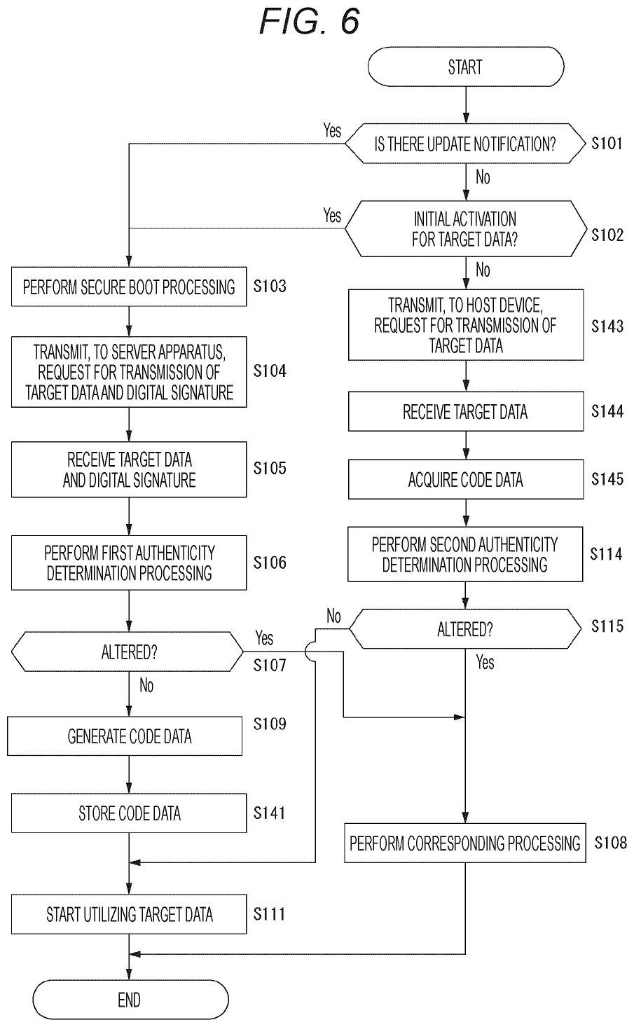

A specific processing procedure will be described with reference to FIG. 6.

Note that processing similar to each piece of processing illustrated in FIG. 3 is denoted by the same step numbers, and description thereof will be omitted as appropriate.

According to the branching processing in Steps S101 and S102, the arithmetic processing unit 30 of the electronic device 3 executes each piece of processing in and after Step S103 as processing for the initial activation.

In Step S107, the arithmetic processing unit 30 performs branching processing corresponding to the processing result of the first authenticity determination processing.

In a case where the arithmetic processing unit 30 determines that the target data D is unaltered, in Step S109, the arithmetic processing unit 30 generates the code data CD by using the common key Kcm and the target data D.

Subsequently, in Step S141, the arithmetic processing unit 30 performs processing of storing the code data CD in the storage unit 31.

Furthermore, according to the branching processing in Steps S101 and S102, the arithmetic processing unit 30 of the electronic device 3 executes each piece of processing in and after Step S143 as processing for the non-initial activation.

Specifically, in Step S143, the arithmetic processing unit 30 transmits, to the host device 2, a request for transmission of the target data D.

Subsequently, in Step S144, the arithmetic processing unit 30 receives the target data D.

Moreover, in Step S145, the arithmetic processing unit 30 acquires the code data CD from the storage unit 31.

In Step S114, the arithmetic processing unit 30 performs the second authenticity determination processing by using the target data D, the code data CD, and the common key Kcm.

That is, in the second modification, the target data D is acquired from another apparatus every time the electronic device 3 is activated, and the code data CD is held in the electronic device 3.

With this arrangement, it is possible to reduce a communication bandwidth and improve processing speed.

### 3-3. Third Modification

A third modification is an example in which both the code data CD and the target data D are stored in the storage unit 31 of the electronic device 3.

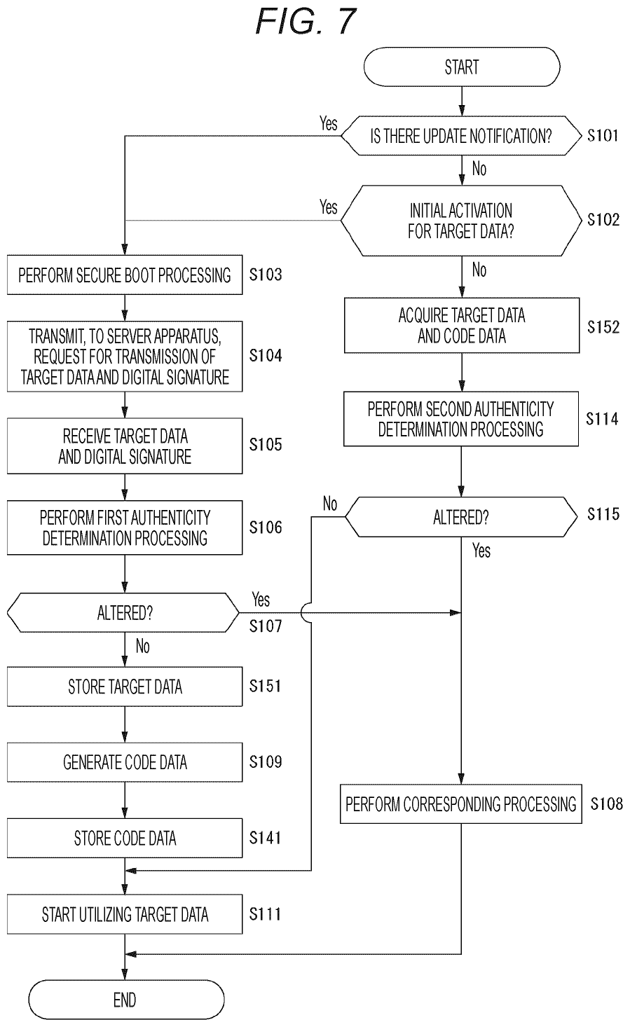

A specific processing procedure will be described with reference to FIG. 7.

Note that processing similar to each piece of processing illustrated in FIG. 6 is denoted by the same step numbers, and description thereof will be omitted as appropriate.

According to the branching processing in Steps S101 and S102, the arithmetic processing unit 30 of the electronic device 3 executes each piece of processing in and after Step S103 as processing for the initial activation.

In Step S107 after executing each piece of processing in Steps S103 to S106, the arithmetic processing unit 30 performs branching processing corresponding to the processing result of the first authenticity determination processing.

In a case where the arithmetic processing unit 30 determines that the target data D is unaltered, in Step S151, the arithmetic processing unit 30 performs processing of storing the target data D in the storage unit 31. Note that the processing of storing the target data D can be executed at an arbitrary timing after the reception processing in Step S105.

Subsequently, in Step S109, the arithmetic processing unit 30 generates the code data CD by using the common key Kcm and the target data D.

In Step S141, the arithmetic processing unit 30 stores the code data CD in the storage unit 31. With this arrangement, both the target data D and the code data CD are stored in the storage unit 31.

Note that, in the present example, the processing of transmitting the target data D and the code data CD to the host device 2 is not performed. However, the target data D and the code data CD may be transmitted to the host device 2 in advance for when the data stored in the electronic device 3 is corrupted, or the like.

According to the branching processing in Steps S101 and S102, the arithmetic processing unit 30 of the electronic device 3 executes each piece of processing in Step S152 and Step S114 as processing for the non-initial activation.

Specifically, in Step S152, the arithmetic processing unit 30 performs processing of acquiring the target data D and the code data CD from the storage unit 31.

In Step S114, the arithmetic processing unit 30 performs the second authenticity determination processing by using the target data D, the code data CD, and the common key Kcm.

That is, in the third modification, the target data D and the code data CD are held in the electronic device 3. With this arrangement, it is possible to reduce a communication bandwidth and improve processing speed.

### 3-4. Fourth Modification

In the above examples, there have been described examples in which the processing of generating the common key Kcm is executed by the electronic device 3. However, the common key Kcm may be generated by a device other than the electronic device 3, which is the server apparatus 1 or the host device 2 for example, and the generated common key Kcm may be transmitted to the electronic device 3 and stored in the storage unit 31.

In a fourth modification, as an example, there will be described an example in which the processing of generating the common key Kcm is performed by the host device 2.

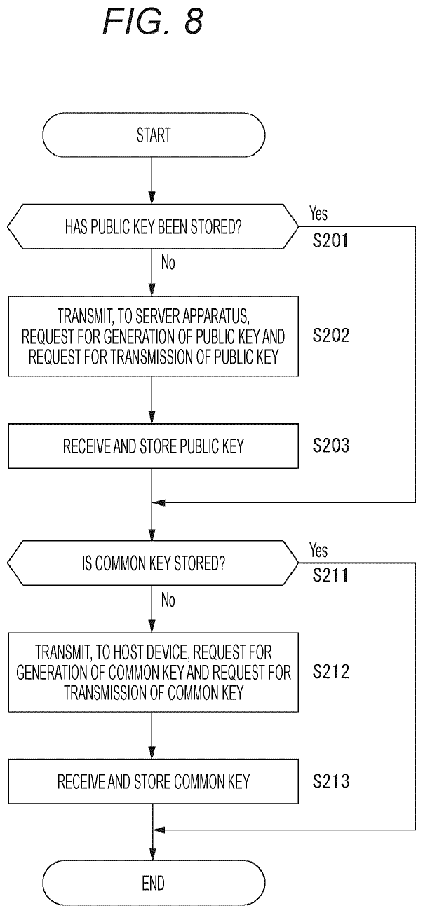

This will be specifically described with reference to FIG. 8.

Note that processing similar to each piece of processing illustrated in FIG. 4 is denoted by the same step numbers, and description thereof will be omitted as appropriate.

The arithmetic processing unit 30 of the electronic device 3 stores the public key Kpb in the storage unit 31 by performing each piece of processing from Step S201 to Step S203.

Subsequently, in Step S211, the arithmetic processing unit 30 determines whether or not the common key Kcm is stored in the storage unit 31.

In a case where it is determined that the common key Kcm is stored in the storage unit 31, the arithmetic processing unit 30 ends a series of processing illustrated in FIG. 8. With this arrangement, various keys necessary for processing can be stored in the storage unit 31.

Meanwhile, in a case where it is determined that the common key Kcm is not stored in the storage unit 31, in Step S212, the arithmetic processing unit 30 transmits, to the host device 2, a request for generation of the common key Kcm and a request for transmission of the common key Kcm.

In response to this, the arithmetic processing unit 20 of the host device 2 performs random number generation processing and the processing of generating the common key Kcm, and performs processing of transmitting the generated common key Kcm to the electronic device 3.

In Step S213, the arithmetic processing unit 30 of the electronic device 3 receives the common key Kcm and performs processing of storing the common key Kcm in the storage unit 31.

In this way, by generating the common key Kcm in a device other than the electronic device 3, the electronic device 3 does not need to include the random number generation function FC2 and common key generation function FC3 illustrated in FIG. 1, and thus a program to be deployed in the electronic device 3 can be reduced in size. Therefore, cost reduction for and downsizing of the electronic device 3 can be achieved.

Note that processing of transmitting the common key Kcm from the host device 2 to the electronic device 3 is preferably performed in an environment in which communication cannot be intercepted or in an environment in which it is difficult to intercept the communication.

### 3-5. Fifth Modification

In the above examples, there have been described examples in which the server apparatus 1 generates the target data D.

In a fifth modification, the host device 2 generates the target data D.

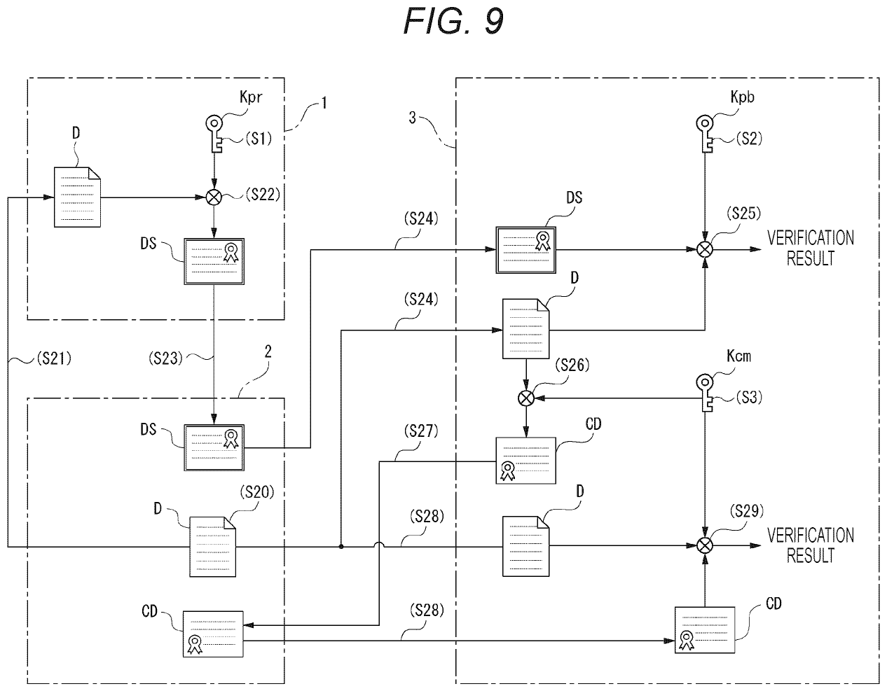

A flow of processing in the present example will be specifically described with reference to FIG. 9.

Note that processing similar to each piece of processing illustrated in FIG. 2 is denoted by the same step numbers, and description thereof will be omitted as appropriate.

First, by performing Steps S1, S2, and S3, the private key Kpr in the public key cryptosystem is stored in the storage unit 11 of the server apparatus 1, and the public key Kpb in the public key cryptosystem and the common key Kcm in the common key cryptosystem are stored in the storage unit 31 of the electronic device 3.

In Step S20, the host device 2 generates the target data D, such as program data, that is to operate in the electronic device 3.

In Step S21, the host device 2 transmits the target data D to the server apparatus 1 in order to obtain the digital signature DS for the target data D.

In Step S22, the server apparatus 1 generates the digital signature DS by using the received target data D and the stored private key Kpr.

In Step S23, the generated digital signature DS is transmitted to the host device 2.

Each piece of processing from Step S24 to Step S27 is processing in the initial activation of the electronic device 3.

In Step S24, the host device 2 transmits the target data D and the digital signature DS to the electronic device 3.

In Step S25, the electronic device 3 performs the first authenticity determination processing (signature verification processing) using the target data D, the digital signature DS, and the public key Kpb. As a result, the electronic device 3 can obtain whether or not the target data D has been altered, that is, can obtain information about a result of the first authenticity determination.

In Step S26, the electronic device 3 generates the code data CD such as the MAC, by using the target data D determined to be “true” by the first authenticity determination, and by using the common key Kcm. In Step S27, the generated code data CD is transmitted to the host device 2.

Each piece of processing in and after Step S28 is processing related to the non-initial activation. Note that, because each piece of processing in Steps S28 and S29 is similar to each piece of processing in Steps S10 and S11 in FIG. 2, description of the processing in Steps S28 and S29 will be omitted.

According to the present example, a manufacturer of the electronic device 3 can generate the target data D and operate the target data D in the electronic device 3, and thus it is possible to expand application of the present technology.

### 3-6. Other Modifications

Note that, in the present example and each example described above, there have been described examples in which the generation of the private key Kpr and the public key Kpb is performed in the server apparatus 1. However, the private key Kpr and the public key Kpb may be generated and managed in the host device 2. That is, the private key Kpr and the public key Kpb may be managed by a user who has purchased the electronic device 3.

Furthermore, in this case, processing of writing the public key Kpb in the storage unit 31 of the electronic device 3 may be performed in the host device 2 after the electronic device 3 is purchased. With this arrangement, because the private key Kpr can be managed at the responsibility of the user who has purchased the electronic device 3, risk management can be facilitated. Furthermore, transmission and reception of the target data D and the digital signature DS between the host device 2 and the server apparatus 1 are not required, and thus leakage of various data can be prevented.

Note that the public key Kpb generated in the host device 2 may be transmitted to the server apparatus 1, and the server apparatus 1 that has received the public key Kpb may perform processing of storing the public key Kpb in the storage unit 31 of the manufactured electronic device 3. In this case, the electronic device 3 is delivered to the user in a state where the public key Kpb is stored in the storage unit 31.

The common key Kcm stored in the electronic device 3 may be used without being changed as long as the target data D is the same, or may be periodically changed even if the target data D is the same. With this arrangement, a risk of leakage of the common key Kcm can be reduced.

Note that the same common key Kcm may be used in a case where the target data D is different. For example, the electronic device 3 may be configured such that the common key Kcm cannot be rewritten.

In addition to the various configurations described above, the first authenticity determination may be executed after executing, by one stage or a plurality of stages, processing for performing the authenticity determination on the public key Kpb corresponding to the private key Kpr.

A risk can be further reduced by utilizing a mechanism of a so-called certificate chain.

Moreover, a plurality of combinations of the private key Kpr and the public key Kpb may be generated, and the plurality of public keys Kpb may be stored in the storage unit 31 of one electronic device 3.

With this arrangement, for example, in a case where it is found that the public key Kpb in use is leaked, it is possible to immediately invalidate the public key Kpb and start using another public key Kpb.

Therefore, it is possible to reduce a risk of leakage and shorten a period for stopping operation of the electronic device 3.

There are various types of possible aspects of the host device 2 and electronic device 3 described above.

For example, the host device 2 may be a monitoring camera, and the electronic device 3 may be an image sensor mounted on the monitoring camera.

Furthermore, the host device 2 may be an in-vehicle electronic control unit (ECU), and the electronic device 3 may be an image sensor as an in-vehicle sensor or vehicle exterior sensor driven by the ECU.

The electronic device 3 can be applied to various types of sensors such as, for example, an RGB sensor that obtains a red (R) image, a green (G) image, and a blue (B) image, a time of flight (ToF) sensor, a thermal sensor, a polarization sensor, a multi-wavelength (multispectral) sensor, an event-based vision sensor (EVS), an infrared (IR) sensor, a short wavelength infrared (SWIR) sensor, a humidity sensor, and a moisture sensor.

### 4. CONCLUSION

As described in the various examples described above, the electronic device 3 includes a first authenticity determination processing unit (first authenticity determination function FC1) that performs, on target data D, first authenticity determination with a public key cryptosystem, a code data generation unit (code data generation function FC4) that generates, from the target data D determined to be true in the first authenticity determination, code data CD with a common key cryptosystem, and a second authenticity determination processing unit (second authenticity determination function FC6) that performs second authenticity determination on the target data D by using the code data CD.

By generating the code data CD with the common key cryptosystem by using the target data D determined to be “true” by the first authenticity determination processing, the code data CD can be used for the second authenticity determination processing for determining authenticity of the target data D. Because the second authenticity determination processing is processing with the common key cryptosystem, the second authenticity determination processing has processing time shorter than the first authenticity determination processing with the public key cryptosystem does.

Therefore, for the initial authenticity determination, by performing the first authenticity determination with the public key cryptosystem having a low risk of leakage, a highly accurate result of the authenticity determination on the target data D can be obtained, and correct code data CD for normal target data D can be obtained. Furthermore, for the second or subsequent authenticity determination, processing time can be shortened by executing the second authenticity determination processing with the common key cryptosystem by using the correct code data CD, and thus faster activation of the electronic device 3, or the like can be achieved.

That is, with this configuration, it is possible to achieve both reduction in risk of key leakage and faster authenticity determination.

As described with reference to FIG. 1 and the like, the electronic device 3 may include a processing selection unit (processing selection function FC7) that performs the first authenticity determination at a time before the code data CD for the target data D is generated, and does not perform the first authenticity determination but performs the second authenticity determination at a time after the code data CD for the target data D is generated.

For example, in a case where, every time the electronic device 3 is activated, the authenticity determination is performed to confirm that the target data D is unaltered, it is not necessary to perform the first authenticity determination processing having a relatively large computational amount, at a time of the second or subsequent activation. Therefore, faster activation of the electronic device 3 can be achieved.

As described with reference to FIG. 1 and the like, the electronic device 3 may include a storage processing unit (storage processing function FC9) that stores in the storage unit 31 the common key Kcm used to generate the code data CD with the common key cryptosystem.

By storing in the electronic device 3 the common key Kcm used for generation of the code data CD, a risk of leakage of the common key Kcm can be reduced.

As described in the fourth modification with reference to FIG. 8 and the like, the electronic device 3 may include a communication processing unit (communication processing function FC10) that receives the common key Kcm from another device (the server apparatus 1 or the host device 2, for example).

Specifically, if the common key Kcm used for generation of the code data CD is generated in an another device, the electronic device 3 may not include a function of generating the common key Kcm. Therefore, capacity of a program stored in the electronic device 3 can be reduced, and, for example, a memory size can be reduced.

As described with reference to FIG. 1 and the like, the electronic device 3 may include a key generation unit (common key generation function FC3) that generates the common key Kcm.

With this arrangement, it is not necessary to generate the common key Kcm in the another device (the server apparatus 1 or the host device 2, for example). Therefore, because transmission and reception of the common key Kcm is not required, a risk of leakage of the common key Kcm can be further reduced. Therefore, authenticity determination of the target data D can be performed with higher accuracy.

As described in the first modification with reference to FIG. 5 and the like, the key generation unit (common key generation function FC3) of the electronic device 3 may first perform the first authenticity determination on the target data D and then generate the common key Kcm.

With this arrangement, because the common key Kcm is not generated until the generation of the code data CD requiring the common key Kcm, a risk of leakage of the common key Kcm can be further reduced.

As described with reference to FIG. 1 and the like, the common key Kcm may be unique to the electronic device 3.

In a case where different common keys Kcm are created for the respective electronic devices 3, in an original common key cryptosystem, it is necessary to hold the common keys Kcm by the number of electronic devices 3 in either the server apparatus 1 or the host device 2, increasing a management cost.

However, in this configuration, the common key Kcm is only in the electronic device 3, and thus a cost for managing the common key Kcm in the server apparatus 1 or the host device 2 is not incurred.

Furthermore, because the common key Kcm is unique to each electronic device 3, it is possible to minimize an extent of impact in a case where the common key Kcm is leaked, and a cost for risk management can be reduced.

As described in the second modification with reference to FIG. 6 and the like, the storage processing unit (storage processing function FC9) of the electronic device 3 may store the code data CD in the storage unit 31.

By storing, in the storage unit 31 of the electronic device 3, the code data CD used for the second authenticity determination, it is not necessary to acquire the code data CD from the another device (the server apparatus 1 or the host device 2, for example) every time the second authenticity determination is performed. Therefore, it is possible to, for example, reduce processing load related to communication processing.

As described in the third modification with reference to FIG. 7 and the like, the storage processing unit (storage processing function FC9) of the electronic device 3 may store the target data D in the storage unit 31.

The target data D is, for example, various programs and the like used by the electronic device 3 for processing, and specifically includes not only software itself but also a patch file applied to software, an AI model used for AI processing, and the like. By storing the target data D in the storage unit 31 of the electronic device 3, it is not necessary to perform communication processing for acquiring the target data D from another device, and thus, it is possible to reduce processing load and a communication bandwidth. Furthermore, in this case, only the target data D may be stored in advance in a process of manufacturing the electronic device 3. It is conceivable that the target data D has a larger capacity than the code data CD does. By storing the target data D in the electronic device 3 in advance, it is not necessary to execute processing of receiving the target data D every time the electronic device 3 is activated, and thus time for the activation can be shortened.

As described with reference to FIGS. 1, 3, and the like, the electronic device 3 may include the communication processing unit (communication processing function FC10) that receives the target data D from the host device 2 every time the electronic device 3 is activated.

By acquiring the target data D from the host device 2 every activation, it is not necessary to store the target data D in a non-volatile memory or the like in the electronic device 3. Therefore, it is possible to downsize the electronic device 3 by reducing capacity of the storage unit 31 included in the electronic device 3.

As described with reference to FIG. 3 and the like, the communication processing unit (communication processing function FC10) of the electronic device 3 may receive the code data CD from the host device 2 every time the electronic device 3 is activated.

By acquiring not only the target data D but also the code data CD from the host device 2 every activation, it is not necessary to secure a region for storing both the target data D and the code data CD in the electronic device 3. Therefore, it is possible to reduce the capacity of the storage unit 31 included in the electronic device 3, and thus to downsize the electronic device 3.

As described with reference to FIG. 1 and the like, the electronic device 3 may be configured to inseparably execute first authenticity determination processing and processing of generating the code data CD.

It is possible to ensure that the code data CD is continuously generated by using the target data D proved, by the first authenticity determination processing, to be unaltered. Therefore, it is possible to exclude possibility that the target data D is altered after the first authenticity determination processing and before the generation of the code data CD, and thus a risk of alteration can be reduced.

As described with reference to FIG. 1 and the like, the electronic device 3 may include the storage unit 31 as a mask ROM that stores a program related to the first authenticity determination processing and a program related to processing of generating the code data CD.

By using a mask ROM method, it is possible to ensure that other processing is not executed between the first authenticity determination processing and processing of generating the code data CD.

As described with reference to FIGS. 1, 3, and the like, the electronic device 3 may include an unalteredness determination processing unit (unalteredness determination function FC5) that performs unalteredness determination processing on a program related to the first authenticity determination processing and a program related to processing of generating the code data CD.

With this arrangement, it is possible to ensure that both processing of the first authenticity determination and the generation of the code data CD are performed on the basis of a normal program. Therefore, the generated code data CD can also be ensured to be correct, and a risk of alteration can be reduced.

As described with reference to FIGS. 1, 3, and the like, the electronic device 3 may include an update determination processing unit (update determination function FC8) that determines whether or not the target data D is to be updated, in which, in a case where the target data D is to be updated, the first authenticity determination processing unit (first authenticity determination function FC1) may perform the first authenticity determination on new, updated target data D, and the code data generation unit (code data generation function FC4) may generate the code data CD for the new target data D.

With this arrangement, in a case where there is no change in the target data D, the target data D can be proved, by the second authenticity determination processing, to be unaltered, and thus, processing time related to authenticity determination can be shortened.

Note that the update determination processing may be executed by the server apparatus 1 or the host device 2. In this case, the electronic device 3 may perform update processing on the basis of update instruction received from the server apparatus 1 or the host device 2, and of the new target data D.

In the information processing method according to the embodiment, a computer apparatus executes first authenticity determination processing (first authenticity determination function FC1) on target data D with a public key cryptosystem, code data generation processing (code data generation function FC4) of generating, from the target data D determined to be true in the first authenticity determination processing, code data CD with a common key cryptosystem, and second authenticity determination processing (second authenticity determination function FC6) of performing second authenticity determination on the target data D by using the code data CD.

A program according to the embodiment causes an arithmetic processing apparatus, such as a CPU for example, to execute first authenticity determination processing (first authenticity determination function FC1) on target data D with a public key cryptosystem, code data generation processing (code data generation function FC4) of generating, from the target data D determined to be true in the first authenticity determination processing, code data CD with a common key cryptosystem, and second authenticity determination processing (second authenticity determination function FC6) of performing second authenticity determination on the target data D by using the code data CD.

With such a program, the above-described arithmetic processing unit 30 of the electronic device 3 can be implemented by an arithmetic processing apparatus such as a microcomputer.

These programs can be recorded in advance in an HDD as a recording medium built in a device such as a computer apparatus, a ROM in a microcomputer having a CPU, or the like. Alternatively, the program can be temporarily or permanently stored (recorded) in a removable recording medium such as a flexible disk, a compact disc read only memory (CD-ROM), a magneto optical (MO) disk, a digital versatile disc (DVD), a Blu-ray Disc (registered trademark), a magnetic disk, a semiconductor memory, or a memory card. Such a removable recording medium can be provided as so-called package software.

Furthermore, such a program can be installed from the removable recording medium into a personal computer or the like, or can be downloaded from a download site via a network such as a local area network (LAN) or the Internet.

Note that the effects described in the present specification are merely examples and are not limited, and other effects may be provided.

Furthermore, the above-described examples may be combined in any way, and the above-described various functions and effects may be obtained even in a case where various combinations are used.

### 5. PRESENT TECHNOLOGY

(1)

An electronic device including
a first authenticity determination processing unit that performs, on target data, first authenticity determination with a public key cryptosystem,
a code data generation unit that generates, from the target data determined to be true in the first authenticity determination, code data with a common key cryptosystem, and
a second authenticity determination processing unit that performs second authenticity determination on the target data by using the code data.
   (2)

The electronic device according to (1),
further including a processing selection unit that performs the first authenticity determination at a time before the code data for the target data is generated, and does not perform the first authenticity determination but performs the second authenticity determination at a time after the code data for the target data is generated.
   (3)

The electronic device according (1) or (2),
further including a storage processing unit that stores, in a storage unit, a common key used for generation of the code data with the common key cryptosystem.
   (4)

The electronic device according to (3), further including a communication processing unit that receives the common key from another device.

(5)

The electronic device according to (3),
further including a key generation unit that generates the common key.
   (6)

The electronic device according to (5),
in which the key generation unit generates the common key after performing the first authenticity determination on the target data for a first time.
   (7)

The electronic device according to any one of (3) to (6),
in which the common key is unique to the electronic device.
   (8)

The electronic device according to any one of (3) to (7), in which the storage processing unit stores the code data in the storage unit.

(9)

The electronic device according to (8),
in which the storage processing unit stores the target data in the storage unit.
   (10)

The electronic device according to any one of (3) to (8),
further including a communication processing unit that receives the target data from a host device every time the electronic device is activated.
   (11)

The electronic device according to (10),
in which the communication processing unit receives the code data from the host device every time the electronic device is activated.
   (12)

The electronic device according to any one of (1) to (11),
inseparably executing processing of the first authenticity determination and processing of generating the code data.
   (13)

The electronic device according to (12),
further including a storage unit as a mask ROM that stores a program related to processing of the first authenticity determination and a program related to processing of generating the code data.
   (14)

The electronic device according to (12),
further including an unalteredness determination processing unit that performs unalteredness determination processing on a program related to processing of the first authenticity determination and a program related to processing of generating the code data.
   (15)

The electronic device according to any one of (1) to (14),
further including an update determination processing unit that determines whether or not the target data is to be updated,
in which, in a case where the target data is to be updated,
the first authenticity determination processing unit performs the first authenticity determination on new, updated target data, and
the code data generation unit generates the code data for the new target data.
   (16)

An information processing method,
in which a computer apparatus executes
first authenticity determination processing on target data with a public key cryptosystem,
code data generation processing of generating, from the target data determined to be true in the first authenticity determination processing, code data with a common key cryptosystem, and
second authenticity determination processing of performing second authenticity determination on the target data by using the code data.

### REFERENCE SIGNS LIST

1 Server apparatus (another device)
2 Host device
3 Electronic device
31 Storage unit
FC1 First authenticity determination function (first authenticity determination processing unit)
FC3 Common key generation function (key generation unit)
FC4 Code data generation function (code data generation unit)
FC5 Unalteredness determination function (unalteredness determination processing unit)
FC6 Second authenticity determination function (second authenticity determination processing unit)
FC7 Processing selection function (processing selection unit)
FC8 Update determination function (update determination processing unit)
FC9 Storage processing function (storage processing unit)
FC10 Communication processing function (communication processing unit)
Kcm Common key
D Target data
CD Code data

1. An electronic device comprising:
a first authenticity determination processing unit that performs, on target data, first authenticity determination with a public key cryptosystem;
a code data generation unit that generates, from the target data determined to be true in the first authenticity determination, code data with a common key cryptosystem; and
a second authenticity determination processing unit that performs second authenticity determination on the target data by using the code data.

2. The electronic device according to claim 1,
further comprising a processing selection unit that performs the first authenticity determination at a time before the code data for the target data is generated, and does not perform the first authenticity determination but performs the second authenticity determination at a time after the code data for the target data is generated.

3. The electronic device according to claim 1,
further comprising a storage processing unit that stores, in a storage unit, a common key used for generation of the code data with the common key cryptosystem.

4. The electronic device according to claim 3,
further comprising a communication processing unit that receives the common key from another device.

5. The electronic device according to claim 3,
further comprising a key generation unit that generates the common key.

6. The electronic device according to claim 5,
wherein the key generation unit generates the common key after performing the first authenticity determination on the target data for a first time.

7. The electronic device according to claim 3,
wherein the common key is unique to the electronic device.

8. The electronic device according to claim 3,
wherein the storage processing unit stores the code data in the storage unit.

9. The electronic device according to claim 8,
wherein the storage processing unit stores the target data in the storage unit.

10. The electronic device according to claim 3,
further comprising a communication processing unit that receives the target data from a host device every time the electronic device is activated.

11. The electronic device according to claim 10,
wherein the communication processing unit receives the code data from the host device every time the electronic device is activated.

12. The electronic device according to claim 1,
inseparably executing processing of the first authenticity determination and processing of generating the code data.

13. The electronic device according to claim 12,
further comprising a storage unit as a mask ROM that stores a program related to processing of the first authenticity determination and a program related to processing of generating the code data.

14. The electronic device according to claim 12,
further comprising an unalteredness determination processing unit that performs unalteredness determination processing on a program related to processing of the first authenticity determination and a program related to processing of generating the code data.

15. The electronic device according to claim 1,
further comprising an update determination processing unit that determines whether or not the target data is to be updated,
wherein, in a case where the target data is to be updated,
the first authenticity determination processing unit performs the first authenticity determination on new, updated target data, and
the code data generation unit generates the code data for the new target data.

16. An information processing method,
wherein a computer apparatus executes
first authenticity determination processing on target data with a public key cryptosystem,
code data generation processing of generating, from the target data determined to be true in the first authenticity determination processing, code data with a common key cryptosystem, and
second authenticity determination processing of performing second authenticity determination on the target data by using the code data.
